(19) United States
(12) Patent Application Publication
(10) Pub. No.: US 2012/0177923 A1
(43) Pub. Date: Jul. 12, 2012

(54) LOW ASH ACTIVATED CARBON AND METHODS OF MAKING SAME

(75) Inventor: Mirissa Sinharakkarage Parasanna Udaya Kumara, Lunwila (LK)

(73) Assignee: Haycarb PLC

(21) Appl. No.: 13/425,334

(22) Filed: Mar. 20, 2012

(51) Int. Cl. C01B 31/08

(52) U.S. Cl. 428/402; 423/445 R

(57) ABSTRACT

Provided are low ash activated carbons, and methods of making the same.

### FIELD OF THE INVENTION

The invention is generally directed to low ash activated carbon materials, and methods for making the same. Such materials are particularly useful as components in polarizing electrodes including those in electric double layer capacitors.

### BACKGROUND OF THE INVENTION

The following description of the background of the invention is provided simply as an aid in understanding the invention and is not admitted to describe or constitute prior art to the invention.

Activated carbon, also known as activated charcoal, is a form of highly porous carbon. The highly porous character of activated carbon makes it useful in a variety of applications which require a highly adsorptive surface, such as a media for purification, solvent recovery, deodorization, and as an antidote for certain poisons. Additionally, activated carbon may be used as an electrode material, such as in double layer capacitance applications, where high surface area allows for increased charge storage density compared to less porous materials.

Activated carbon typically possesses several attractive qualities for double layer capacitance applications such as low material cost, high surface area, cyclability, long-term stability, and resistance to electrochemical oxidation/reduction. However, in such applications, the additional properties of high capacitance and low equivalent series resistance (ESR) are desired. Improvements in these properties can be achieved with more highly purified carbons. Particularly, improvements in the purity of activated carbons leads to a lower initial ESR, as well as lower ESR increase over the operation of an electronic device, enhancing the durability of electrodes made from such materials.

Activated carbons made from non-synthetic sources (i.e., natural carbonaceous sources such as wood, coal, coconut shell, etc.), are typically attractively priced and are available with sufficiently high surface area; however, these carbons typically have higher than desirable levels of contaminants. Thus, such carbons may particularly benefit from reduction of contaminants.

### SUMMARY OF THE INVENTION

The present invention provides low ash activated carbons, along with their methods of production. Further provided are methods for reducing ash content in an activated carbon, electrodes comprising low ash activated carbons, and electric double layer capacitors comprising such electrodes.

In one aspect, the present invention provides activated carbon from a natural carbonaceous source material, said activated carbon comprising less than 500 ppm calcined ash; such as less than about 400 ppm calcined ash; such as less than about 350 ppm calcined ash.

In some related embodiments, the activated carbons comprise less than about 70 ppm chloride, such as less than about 50 ppm, such as less than about 35 ppm.

In some embodiments, the activated carbon comprises particles with the size distribution D₁₀=about 2.0-3.5 microns; D₅₀=about 7.0-9.0 microns; D₉₀=about 15.0-18.0 microns; and D₁₀₀=about 45.0 microns. In some embodiments, the activated carbon comprises particles with the size distribution D₁₀=about 1.5-3.0 microns; D₅₀=about 5.0-7.0 microns; D₉₀=about 11.0-15.0 microns; and D₁₀₀=about 30.0 microns. In some embodiments, the activated carbon comprises particles with the size distribution D₁₀=about 1.0-2.0 microns; D₅₀=about 3.0-7.0 microns; D₉₀=about 9.0-11.0 microns; and D₁₀₀=about 25.0 microns. In some embodiments, the activated carbon comprises particles with the size distribution D₁₀=about 0.5 microns; D₅₀=about 2.0 microns; D₉₀=about 3.0 microns; and D₁₀₀=about 7.0 microns. In some embodiments, the activated carbon comprises particles with the size distribution D₁₀=about 0.2-0.5 microns; D₅₀=about 2.0-3.0 microns; D₉₀=about 3.0-4.0 microns; and D₁₀₀=about 7.0-10.0 microns.

In some embodiments, the activated carbon comprises less than about 2% total surface oxygen; such as less than about 1.5%; such as less than about 1.2%. In some embodiments, the activated carbon comprises less than about 1% nitrogen; such as less than about 0.5%; such as less than about 0.2%. In some embodiments, the activated carbon comprises less than about 2% hydrogen; such as less than about 1.5%; such as less than about 0.9%. In some embodiments, the activated carbon comprises less than about 0.1 miliequivalents per gram (meq/g) total —COOH, hydroxyl, and lactone functional groups; such as less than about 0.06 meq/g; such as less than about 0.03 meq/g.

In some embodiments, the activated carbon has a bulk density within the range of about 0.20 to 0.40 g/cc; such as within the range of about 0.35 to 0.40 g/cc.

In some embodiments, the activated carbon has a BET surface area of about 1700 to 3200 m²/g; such as about 1700 to 2500 m²/g; such as about 1700 to 2000 m²/g.

In some embodiments, the activated carbon has a benzene adsorption within the range of about 60.5% to 130%; such as within the range of about 60.5% to 100%, or within the range of about 100% to 130%.

In some embodiments, the activated carbon has a pore volume of about 0.8 to 2.2 cc/g; such as about 0.8 to 2.0 cc/g.

In some embodiments, the activated carbon has an average pore diameter of about 18 to 25 Angstroms; such as about 18 to 21 Angstroms, or about 20 to 25 Angstroms.

In some embodiments, the activated carbon has been washed with at least one acidic solution to reduce calcined ash. In some embodiments, the activated carbon has been washed with at least one basic solution to reduce calcined ash. In some embodiments, the activated carbon has been washed with a plurality of increasingly basic solutions to reduce calcined ash. In some embodiments, the activated carbon has been washed with at least one acid and at least one base to reduce calcined ash. In some embodiments, the activated carbon has been washed with at least one acid followed by at least one base to reduce calcined ash.

In a second aspect, methods are presented for making activated carbon. The methods include: (i) carbonizing a carbonaceous source material to generate a char; (ii) activating the char to form an activated carbon; and (iii) washing the activated carbon with a plurality of increasingly basic solutions.

In some embodiments, the plurality of increasingly basic solutions includes three or more increasingly basic solutions. In some embodiments, the plurality of increasingly basic solutions comprises an aqueous ammonium hydroxide solution. In some embodiments, the plurality of increasingly basic solutions comprises an aqueous alkali or alkali earth hydroxide solution.

In some embodiments, the char generated in step (i) is processed by one or more steps to generate char particles in the size range of about 2.4 mm to about 6.3 mm prior to activation.

In some embodiments, the methods further comprise washing the activated carbon generated in step (ii) with at least one acidic solution prior to washing with said plurality of basic solutions. In some related embodiments, the at least one acidic solution comprises an aqueous hydrochloric acid solution, an aqueous nitric acid solution, or a mixture thereof.

In some embodiments, the methods further comprise washing the activated carbon generated in step (ii) with at least one acidic solution between washing with two of said plurality of basic solutions. In some related embodiments, the at least one acidic solution comprises an aqueous hydrochloric acid solution, an aqueous nitric acid solution, or a mixture thereof.

In some embodiments, the washed activated carbon generated in step (iii) is processed by one or more steps such that activated carbon resulting from the method comprises activated carbon particles. In some related embodiments, the resulting activated carbon particles have a size distribution of D₁₀=about 2.0-3.5 microns; D₅₀=about 7.0-9.0 microns; D₉₀=about 15.0-18.0 microns; and D₁₀₀=about 45.0 microns. In some embodiments, the activated carbon comprises particles with the size distribution D₁₀=about 1.5-3.0 microns; D₅₀=about 5.0-7.0 microns; D₉₀=about 11.0-15.0 microns; and D₁₀₀=about 30.0 microns. In some embodiments, the activated carbon comprises particles with the size distribution D₁₀=about 1.0-2.0 microns; D₅₀=about 3.0-7.0 microns; D₉₀=about 9.0-11.0 microns; and D₁₀₀=about 25.0 microns. In some embodiments, the activated carbon comprises particles with the size distribution D₁₀=about 0.5 microns; D₅₀=about 2.0-3.0 microns; D₉₀=about 3.0-4.0 microns; and D₁₀₀=about 7.0-10.0 microns.

In some embodiments, the activated carbon resulting from the method comprises less than 500 ppm calcined ash; such as less than about 400 ppm calcined ash; such as less than about 350 ppm calcined ash.

The methods of making activated carbons and the activated carbons described herein may utilize or be made from any suitable carbonaceous source material known in the art. In preferred embodiments, activated carbons are made from natural carbonaceous source materials. In especially preferred embodiments, natural carbonaceous source materials derived from an animal, botanical, or mineral source are carbonized to make a char, which is subsequently activated. Preferred natural carbonaceous source materials include, but are not limited to, wood, coal, or nut shells (including coconut shells). In some embodiments, char is derived by carbonizing an animal, botanical, or mineral carbonaceous source in an inert atmosphere. In alternate embodiments, char is derived by carbonizing an animal, botanical, or mineral carbonaceous source in an oxygen containing atmosphere. Activation of char may be conducted by any activation method known in the art. In some preferred embodiments, the activated carbon is generated by steam activation.

In a third aspect, methods are presented for reducing the amount of calcined ash in an activated carbon. These methods include the steps of: i) washing an activated carbon one or more times with acidic solutions to generate an acid washed activated carbon; ii) rinsing the acid washed activated carbon with water to generate a first rinsed activated carbon; iii) washing the first rinsed activated carbon one or more times with a basic solution to generate a base washed activated carbon; iv) rinsing the base washed activated carbon to generate a second rinsed activated carbon; and v) optionally repeating steps i)-iv) until the resulting rinsed activated carbon contains less than 500 ppm calcined ash.

In some embodiments, the acid of step i) comprises an aqueous hydrochloric acid solution, an aqueous nitric acid solution, or a mixture thereof.

In some embodiments, each time step iii) is repeated, the first rinsed activated carbon is washed with an increasingly basic solution.

In some embodiments, a basic solution used in at least one iteration of step comprises aqueous ammonium hydroxide solution.

In some embodiments, a basic solution used in at least one iteration of step iii comprises an aqueous alkali or alkali earth hydroxide solution.

In some embodiments, steps i)-iv) are repeated until the resulting activated carbon contains less than about 400 ppm calcined ash; such as less than about 350 ppm calcined ash.

The methods presented herein for reducing the amount of calcined ash in an activated carbon may be applied to activated carbon generated from any carbonaceous source by any activation method known in the art. In preferred embodiments, the methods are applied to activated carbon from a natural carbonaceous source material, such as a carbonaceous material derived from an animal, botanical, or mineral source. Preferred natural carbonaceous source materials include, but are not limited to, wood, coal, or nut shells (including coconut shells). In some preferred embodiments, the methods are applied to activated carbon generated by steam activation.

In another aspect, electrodes comprising the activated carbons of the present invention or comprising activated carbons produced by methods of the present invention are also provided. Such electrodes may be incorporated into various devices, including electric double-layer capacitors.

As used herein, the term “natural carbonaceous source material” refers to a non-synthetic carbonaceous source material. Such source materials may be ultimately be derived from various animal, botanical, or mineral sources. Exemplary natural carbonaceous source materials include, but are not limited to feathers, wood or other natural sources of cellulose, nut shells (including coconut shell), and coal.

As used herein, the term “calcined ash” refers to the portion of an activated carbon which remains after the activated carbon has been calcined under the appropriate conditions (including sufficient time and temperature) to remove the volatile fraction of the activated carbon through thermal decomposition, phase transition, or any other chemical mechanism. Residual calcined ash typically comprises metals and metal ions (e.g., sodium, potassium, calcium, magnesium, iron, nickel, etc.) which may be detrimental to electrode performance. Thus, the level of calcined ash, expressed as a % by weight of original activated carbon, is reflective of the purity of the activated carbon. Calcined ash levels provided herein reflect calcined ash levels measured by the ASTM D2866-94 (2004) standard test method.

As used herein, particle size distributions are given in terms of average particle diameter by mass. D₅₀. A D₅₀ value is the median mass diameter, or the value at which half the population is below and half the population is above. Additional values provided for particle size distributions include D₁₀, D₉₀, and D₁₀₀, which are similarly defined as providing values under which 10%, 90%, and 100% of the population, respectively, resides below. The particle size distributions provided herein are measured using laser particle analysis techniques as known in the art.

As used herein, the term “acidic solution” or “acid” refers to an aqueous solution where the pH is less than 7. Conversely, the term “basic solution” or “base” refers to an aqueous solution where the pH is higher than 7.

As used herein, unless otherwise stated, the singular forms “a,” “an,” and “the” include plural reference.

As used herein, the term “about” in quantitative terms refers to plus or minus 10%. For example, “about 3%” would encompass 2.7-3.3% and “about 10%” would encompass 9-11%. Moreover, where “about” is used herein in conjunction with a quantitative term it is understood that in addition to the value plus or minus 10%, the exact value of the quantitative term is also contemplated and described. For example, the term “about 3%” expressly contemplates, describes and includes exactly 3%.

The summary of the invention described above is non-limiting and other features and advantages of the invention will be apparent from the following detailed description of the invention, and from the claims.

### BRIEF DESCRIPTION OF THE DRAWINGS

FIG. 1 shows an exemplary flow chart for production of low calcined ash activated carbons.

FIGS. 2A and B show exemplary cyclic voltammograms generated from electrodes made from an activated carbon of the present invention. Details are discussed in Example 7.

FIGS. 3A and 3B show exemplary electrochemical impedance spectra generated from electrodes made from an activated carbon of the present invention. Details are discussed in Example 7.

### DETAILED DESCRIPTION OF THE INVENTION

High purity (e.g., low calcined ash) activated carbons, and their methods of making, are described. Such activated carbons are particularly useful as electrode materials in energy storage applications.

Specifically, activated carbons are described which comprise low levels of calcined ash. Activated carbons with low levels of calcined ash are particularly suited for use in electrodes in energy storage applications because several problems associate with higher levels of metals and metallic ions are reduced with such materials. For example, deposition of “needle like” crystals of transition metal salts on cathode surfaces is reduced. Furthermore, activated carbons with low levels of calcined ash contain low levels of chloride counter ions. Reduction of the chloride content results in improved stability of the electrolyte and overall operational life of the energy storage device.

In the activated carbons described herein, chloride content is reduced relative to activated carbons with higher levels of calcined ash. For example, chloride is preferably present at less than about 70 ppm; such as less than about 50 ppm; such as less than about 35 ppm.

In the activated carbons described herein; metal or metallic ion constituents are also reduced relative to activated carbons with higher levels of calcined ash. For example, sodium is preferably present at less than about 45 ppm, such as less than about 40 ppm, such as less than about 35 ppm, such as less than about 30 ppm; potassium is preferably present at less than about 50 ppm, such as less than about 45 ppm, such as less than about 40 ppm, such as less than about 35 ppm; calcium is preferably present at less than about 45 ppm, such as less than about 40 ppm, such as less than about 35 ppm, such as less than about 30 ppm; magnesium is preferably present at less than about 20 ppm, such as less than about 17 ppm, such as less than about 14 ppm, such as less than about 10 ppm; iron is preferably present at less than about 45 ppm, such as less than about 40 ppm, such as less than about 35 ppm, such as less than about 30 ppm; nickel is preferably present at less than about 10 ppm, such as less than about 8 ppm, such as less than about 6 ppm, such as less than about 4 ppm; chromium is preferably present at less than about 5 ppm, such as less than about 3 ppm; such as less than about 1.5 ppm; copper is preferably present at less than about 7.5 ppm, such as less than about 5 ppm, such as less than about 2.5 ppm.

Thus, activated carbons are described herein preferably comprise less than about 500 ppm; such as less than about 450 ppm; such as less than about 400 ppm; such as less than about 350 ppm calcined ash.

Another important characteristic that affects the performance of activated carbon based electrodes in energy storage devices is the nature and amount of surface groups on the activated carbon. This is because high charge-discharge applications demand low capacitor equivalent series resistance (ESR). Certain surface functional groups, such as total surface oxygen, affects resistivity of activated carbon electrodes by increasing the barrier for electrons to transfer within an electrode. Thus, surface oxygen in activated carbon electrode materials is one contributing factor to capacitor ESR, with lower surface oxygen being desirable in energy storage device applications.

Further, the presence of certain surface groups influences the electrochemical interface between the carbon surface and its double-layer properties, including wettability, point of zero charge, electrical contact resistance, adsorption of ions (i.e. capacitance), and self-discharge characteristics (i.e. leakage). Surface groups impacting one or more of these properties include heteroatoms, such as oxygen, hydrogen, nitrogen, sulfur and halogens. These heteroatoms may derive from the starting carbonaceous material, from one or more reagents used in the generation of the activated carbon (e.g., a reagent used in the activation process or in washing the activated carbon), or from other environmental sources such as the atmosphere or equipment contacting the activated carbon during production.

Of particular import are surface oxides, such as carboxylic (—COOH), lactonic, and phenolic functionalities. These three surface oxides in particular are generally considered acidic surface oxides that form when carbons are exposed to oxygen at elevated temperatures (about 200 to 700° C.) or by reactions with oxidizing solutions at lower temperatures (including room temperature). The extent of oxygen retained as physically adsorbed molecular oxygen or as surface oxygen complexes is believed to strongly influence the rate and mechanism of capacitor self-discharge. In particular, high concentrations of the acidic surface functionalities are prone to exhibit high rates of self-discharge. Thus, lower concentrations of acidic surface functionalities (including carboxylic (—COOH), lactonic, and phenolic functionalities) are desirable for energy storage applications.

In some embodiments, activated carbons of the present invention comprise less than about 2% total surface oxygen; such as less than about 1.5%; such as less than about 1.2%. In some embodiments, the activated carbons comprise less than about 1% nitrogen; such as less than about 0.5%; such as less than about 0.2%. In some embodiments, the activated carbons comprise less than about 2% hydrogen; such as less than about 1.5%; such as less than about 0.9%. In some embodiments, the activated carbons comprise less than about 0.1 miliequivalents per gram (meq/g) total carboxylic (—COOH), hydroxyl, and lactone functional groups; such as less than about 0.06 meq/g; such as less than about 0.03 meq/g.

Other characteristic that affect the performance of activated carbon based electrodes in energy storage devices are physical properties of the activated carbon, such as surface area, pore volume and average pore diameter, density, and particle size distribution, albeit to a lesser extent. This is because the electrical properties of carbon materials are directly related to their structure. For electrode applications, the resistivity/conductivity of the material is of primary concern, and is influenced both by intrinsic physical properties of the material, as well as aggregate physical properties arising from a collection of fine particles.

In some embodiments, the activated carbons of the present invention have a BET surface area of about 1700 to 3200 m²/g; such as about 1700 to 2500 m²/g; such as about 1700 to 2000 m²/g.

In some embodiments, the activated carbon has a benzene adsorption within the range of about 60.5% to 130%; such as within the range of about 60.5% to 100%, or within the range of about 100% to 130%.

In some embodiments, the activated carbon has a pore volume of about 0.8 to 2.2 cc/g; such as about 0.8 to 2.0 cc/g.

In some embodiments, the activated carbon has an average pore diameter of about 18 to 25 Angstroms; such as about 18 to 21 Angstroms, or about 20 to 25 Angstroms.

In some embodiments, the activated carbon has a bulk density within the range of about 0.20 to 0.40 g/cc; such as within the range of about 0.35 to 0.40 g/cc.

In some embodiments, the activated carbon comprises particles with the size distribution D₁₀=about 2.0-3.5 microns; D₅₀=about 7.0-9.0 microns; D₉₀=about 15.0-18.0 microns; and D₁₀₀=about 45.0 microns. In some embodiments, the activated carbon comprises particles with the size distribution D₁₀=about 1.5-3.0 microns; D₅₀=about 5.0-7.0 microns; D₉₀=about 11.0-15.0 microns; and D₁₀₀=about 30.0 microns. In some embodiments, the activated carbon comprises particles with the size distribution D₁₀=about 1.0-2.0 microns; D₅₀=about 3.0-7.0 microns; D₉₀=about 9.0-11.0 microns; and D₁₀₀=about 25.0 microns. In some embodiments, the activated carbon comprises particles with the size distribution D₁₀=about 0.5 microns; D₅₀=about 2.0 microns; D₉₀=about 3.0 microns; and D₁₀₀=about 7.0 microns. In some embodiments, the activated carbon comprises particles with the size distribution D₁₀=about 0.2-0.5 microns; D₅₀=about 2.0-3.0 microns; D₉₀=about 3.0-4.0 microns; and D₁₀₀=about 7.0-10.0 microns.

Activated carbon materials of the present invention are not limited by their carbonaceous source material. They may be prepared from any suitable carbonaceous source known in the art, including natural or synthetic carbonaceous source materials. In some preferred embodiments, activated carbons of the present invention are prepared from natural carbonaceous source materials, such as a carbonaceous source material derived from an animal (e.g., bird feathers), botanical (e.g., wood, peat, nut shells, etc.), or mineral (e.g. coal, petroleum pitch, etc.) source. In particularly preferred embodiments, activated carbons of the present invention are prepared from nut shells, such as coconut shells.

Activated carbons of the present invention are also not limited by the carbonization process used to convert a carbonaceous source material into a char (or charcoal). In some embodiments, the carbonization process is conducted in an inert atmosphere. In other embodiments, the carbonization process is conducted in an oxygen containing atmosphere.

In some embodiments, after a carbonaceous source material is carbonized, the resulting char may be subjected to one or more processes prior to activation. For example, a char may be cleaned and sized so as to remove impurities, such as sand and rock, and achieve a desired char particle size distribution prior to activation. Cleaning and sizing may be conducted by any method known in the art. In some embodiments, cleaning and sizing of char may be conducted by screening char prior to activation to remove particles greater than about 10 mm and less than about 1 mm, such as greater than about 7 mm and less than about 2 mm, such as greater than about 6.4 mm and less than about 2.4 mm.

Activated carbons of the present invention are also not limited by the activation process used to convert a char to an activated carbon. Various activation techniques known in the art can be used, such as oxidizing gas activation (e.g., steam activation), or chemical activation. In preferred embodiments, activated carbons are prepared by steam activation.

After activation, the resulting activated carbons may be subjected to one or more processing techniques prior to chemical washing. For example, an activated carbon may be de-stoned, blended, crushed, subjected to a density separation, screened, etc., in any combination prior to chemical washing. De-stoning may be conducted by any method known in the art and may be used to reduce the amount of sand/stone in the activated carbon. Blending may be conducted by any method known in the art and may be used to improve homogeneity of the activated carbon and help achieve uniformity of surface area and bulk density. Crushing may be used to achieve a desired particle size and/or shape distribution, as well as affect the ultimate bulk density. Crushing may be conducted by any method known in the art and conducted in one or more steps to ultimately arrive at the desired product. Density separation may be conducted by any method known in the art and may be used to increase the density of the ultimate product, while improving purity. Screening may be conducted by any method known in the art and may be employed to ensure that the activated carbon is of a desired particle size range.

The thus prepared or otherwise obtained activated carbon is then subjected to a chemical washing protocol to reduce the level of calcined ash. The chemical washing protocol may include washing the activated carbon with at least one aqueous acidic solution. Any aqueous solution with a pH less than 7 is considered an acidic solution and may be used in the chemical washing protocol. However, particularly preferred acidic solutions include hydrochloric acid, nitric acid, or mixtures thereof.

The preferred concentration of the one or more acidic solutions will vary depending on the identity of the acid and the length of time of the wash. For example, in some embodiments, the activated carbon may be washed with hydrochloric acid at a concentration of between about 0.1 Normal and about 1 Normal for between about five minutes to three hours. In some embodiments, the activated carbon may be washed with nitric acid at a concentration of between about 0.05 Normal and 1 Normal for between about thirty minutes to six hours. The concentration ranges and times listed above are not intended to be limiting, as, e.g., lower concentration washes with longer contact time or higher concentration washes with shorter contact time may be used to achieve similar results.

The preferred amount of acid solution relative to activated carbon will also vary depending on the identity of the acid, the length of time of the wash, and the step of the chemical washing protocol. However, generally the volume of acid solution is preferably between one and twelve times the volume of activated carbon being washed.

Additionally, the chemical washing protocol may include washing the activated carbon with at least one aqueous basic solution. Any aqueous solution with a pH greater than 7 is considered a basic solution, and may be used in the chemical washing protocol. However, particularly preferred basic solutions include aqueous alkali or alkali earth hydroxide solutions (such as potassium hydroxide, sodium hydroxide, etc.) and ammonium hydroxide.

The preferred concentration of the one or more basic solutions will vary depending on the identity of the acid and the length of time of the wash. For example, in some embodiments, the activated carbon may be washed with ammonium hydroxide at a concentration of between about 0.02 Normal and about 0.2 Normal for at least one hour, such as between about one and six hours. In some embodiments, the activated carbon may be washed with ammonium hydroxide at a concentration of between about 0.3 Normal and 0.5 Normal for between about thirty minutes to six hours. In some embodiments, the activated carbon may be washed with an aqueous alkali or alkali earth hydroxide solution (such as sodium hydroxide) at a concentration of about 2 to 10 wt %, such as about 5 wt %, for at least one hour, such as at least two hours, such as between about two and six hours. The concentration ranges and times listed above are not intended to be limiting, as, e.g., lower concentration washes with longer contact time or higher concentration washes with shorter contact time may be used to achieve similar results.

In some embodiments, the chemical washing protocol comprises washing the activated carbon with a plurality of increasingly basic solutions. As used herein, washing with a plurality of increasingly basic solutions refers to washing with a series of solutions with increasing hydroxide concentrations. This plurality of increasingly basic washes may be employed by washing with a first basic solution, immediately followed by washing with a second basic solution. Alternatively, one or more washes with an acidic solution, de-ionized water, or any combination thereof may be used between washes with the plurality of increasingly basic solutions.

The acidic washing and basic washing described above may both be included in a chemical washing protocol to reduce calcined ash. As such, in some embodiments, the chemical washing protocol comprises washing the activated carbon with at least one acid and at least one base. In some embodiments, the chemical washing protocol comprises washing the activated carbon with at least one acidic solution followed by washing with at least one basic solution. In some embodiments, the chemical washing protocol comprises washing the activated carbon with at least one basic solution followed by washing with at least one acidic solution.

Additionally, the chemical washing protocol may include washing the activated carbon with de-ionized water. A water washing step may be employed at any point in the chemical washing, e.g., as an initial washing step, following washing with either an acidic or basic solution, as a final washing step, or any combination thereof.

An exemplary chemical washing protocol for reducing calcined ash in an activated carbon which includes washes with acidic solutions, basic solutions, and water, is provided in Table 1. This example is not intended to be limiting, and is provided merely as an illustration.

TABLE 1
Exemplary Chemical Washing Protocol

| | | | Relative Volume |
|---|---|---|---|
| | | | (v:v wash |
| | Wash Solution | Soak Time | reagent:activated |
| Step | (concentration) | (rain) | carbon) |
| 1 | HCl_{(aq)} (0.1-0.2N) | 5-120 | 6-12:1 |
| 2 | HNO_{3(aq)} (0.05-0.1N) | 180-360 | 5:1 |
| 3 | De-ionized H₂O | *Rinse | 3-6:1 |
| 4 | NH₄OH_{(aq)} (0.02-0.2N) | ≧60 | 2-4:1 |
| 5 | De-ionized H₂O | *Rinse | 3-5:1 |
| 6 | HCl_{(aq)} (1-11N) | ≧60 | 1-3:1 |
| 7 | De-ionized H₂O | 50 | 3-6:1 |
| 8 | NH₄OH_{(aq)} (2N) | 30-60 | 1-3:1 |
| 9 | De-ionized H₂O | 60-120 | 5:1 |
| 10 | NaOH_{(aq)} (5%) | ≧120 | 1:1 |
| 11 | De-ionized H₂O | *Rinse | 3-7:1 |
| 12 | HCl_{(aq)} (0.2-0.4N) | ≧30 | 2-4:1 |
| 13 | HNO_{3(aq)} (0.2-0.4N) | ≧30 | 2-4:1 |
| 14 | NH₄OH_{(aq)} (0.3-0.5N) | 30-240 | 2-4:1 |
| 15 | De-ionized H₂O | ≧300 | 5-10:1 |

When a chemical washing protocol is complete, the resulting activated carbon may be dried by any method known in the art. In some embodiments, an indirectly heated rotary dryer may be used to dry the washed activated carbon to reach a desired moisture content. For example, washed activated carbon may be dried at a temperature of about 150° C. to 300° C. with a drying rate of between about 200-500 kg/hr. After drying, the activated carbon is physically stable black granules, preferably with moisture content of less than about 2%, such as a less than about 1%, such as less than about 0.5%.

After drying, the activated carbon may be brought in close proximity to or in contact with powerful magnets to remove magnetic particles, especially residual ferric metals. Such treatment further reduces magnetic contaminants from the resulting activated carbon.

After washing and drying, the activated carbon may also be subjected to a surface treatment protocol to modify the amounts of various functional groups present in the pore structure. As described above, several surface functional groups which affect the performance of activated carbon based electrodes in energy storage devices may be present. Activated carbons may be subject to a surface treatment protocol to modify the amounts of one or more heteroatoms, such as oxygen, hydrogen, nitrogen, sulfur and halogens, and carboxylic (—COOH), lactonic, and phenolic functionalities are present.

For example, after washing and drying, the activated carbon may be subjected to a surface treatment protocol comprising heating the activated carbon to a temperature of about 800° C. or higher, such as between about 800° C. and 1100° C., such as between about 900° C. and 1100° C., in a nitrogen gas environment to reduce surface functional groups, including total surface oxygen content. Treated as such, activated carbons of the present invention may have total surface oxygen content of less than about 2%; such as less than about 1.5%; such as less than about 1.2%. Activated carbons of the present invention may also comprise less than about 1% nitrogen; such as less than about 0.5%; such as less than about 0.2%. Activated carbons of the present invention may also comprise less than about 2% hydrogen; such as less than about 1.5%; such as less than about 0.9%. Activated carbons of the present invention may also comprise less than about 0.1 miliequivalents per gram (meq/g) total carboxylic (—COOH), hydroxyl, and lactone functional groups; such as less than about 0.06 meq/g; such as less than about 0.03 meq/g.

Finally, correct sizing of activated carbon particles is important to achieve an appropriate packing density and to facilitate electrode film production. Any process known in the art to manipulate particle shape and size, such as milling, may be used to process activated carbons of the instant invention. Processes which manipulate particle shape and size while maintaining activated carbon purity are particularly preferred.

In some embodiments, the activated carbon comprises particles with the size distribution D₁₀=about 2.0-3.5 microns; D₅₀=about 7.0-9.0 microns; D₉₀=about 15.0-18.0 microns; and D₁₀₀=about 45.0 microns. In some embodiments, the activated carbon comprises particles with the size distribution D₁₀=about 1.5-3.0 microns; D₅₀=about 5.0-7.0 microns; D₉₀=about 11.0-15.0 microns; and D₁₀₀=about 30.0 microns. In some embodiments, the activated carbon comprises particles with the size distribution D₁₀₀=about 1.0-2.0 microns; D₅₀=about 3.0-7.0 microns; D₉₀=about 9.0-11.0 microns; and D₁₀₀=about 25.0 microns. In some embodiments, the activated carbon comprises particles with the size distribution D₁₀=about 0.5 microns; D₅₀=about 2.0 microns; D₉₀=about 3.0 microns; and D₁₀₀=about 7.0 microns. In some embodiments, the activated carbon comprises particles with the size distribution D₁₀=about 0.2-0.5 microns; D₅₀=about 2.0-3.0 microns; D₉₀=about 3.0-4.0 microns; and D₁₀₀=about 7.0-10.0 microns.

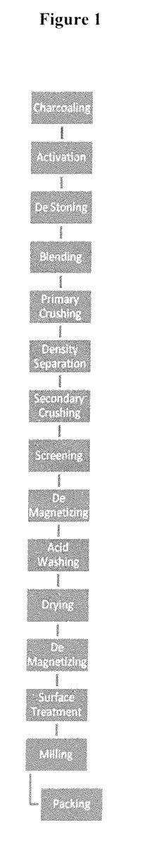

The individual processes described above, or combinations thereof, may be included in methods to make activated carbons, the activated carbons preferably comprising less than 500 ppm calcined ash; such as less than about 400 ppm calcined ash; such as less than about 350 ppm calcined ash. Such methods will generally include carbonization of a carbonaceous starting material to form a char; activating the char to form an activated carbon; and subjecting the activated carbon to some variant of a chemical washing protocol; each according to the descriptions above. A exemplary flow chart, including these and several of the optional steps described above, is shown in FIG. 1.

In another aspect, individual processes described above, or combinations thereof, may be included in methods to reduce the calcined ash content of activated carbons to less than 500 ppm calcined ash; such as less than about 400 ppm; such as less than about 350 ppm. Such methods will generally include some variant of a chemical washing protocol according to the description above.

As is known in the art, an electric double layer capacitor utilizes electrical energy stored in an electric double layer formed at the interface of a polarizing electrode and an electrolyte solution. Also as is know in the art, activated carbon can be used as an electrode material in polarizing electrodes. Used as such, the activated carbon can be regarded as providing a location for solvent and electrolyte ions to interact electrochemically. Thus, the physical and chemical properties and microscopic structure of the activated carbon are factors that influence the performance of activated carbon polarizing electrodes, and the devices, such as capacitors and supercapacitors, utilizing the polarizing electrodes.

The present invention also provides polarizing electrodes comprising activated carbons described herein (or activated carbons generated by methods described herein). These electrodes may be made by any method known in the art. Further provided are well known devices, such as capacitors and supercapacitors, incorporating such polarizing electrodes. For example, a capacitor or supercapacitor of the present invention will comprise a current collector, a polarizing electrode, a separator, and an electrolyte; wherein the polarizing electrode comprises an activated carbon as described herein (or an activated carbon generated by a method described herein).

### EXAMPLES

### Example 1

### Preparation of Activated Carbon from Coconut Shell Carbonaceous Material

Coconut shell carbonaceous material was carbonized in the presence of air according to the processes described in IN Patent No. 2642/DEL/2008, Sri Lanka Patent No. 15195, Indonesian Patent No. P.00.2009.00512, and Thailand Patent No. 0901004612.

The resulting charcoal was subjected to pre-cleaning and sizing to remove soft particles larger than about 6.3 mm and fine particles smaller than about 2.3 mm, including sand and stones. To do so, the charcoal was passed through a double deck rotary screen with a rotation speed of about 25 rpm. After screening, the material was subjected to additional processing to remove threads, jute twines, an other fibrous material.

The pre-cleaned and sized charcoal was then subjected to steam activation in rotary kilns operating at about 650 to 1100° C. Steam activation was achieved by injecting steam directly into the charcoal bed at an angle of between about 90° and 120° and an injection velocity of between about 120 m/s to 270 m/s under 15 PSI line pressure. The resulting activated carbon had BET surface area of between about 1700 m²/g to about 3200 m²/g; pore volume between about 0.8 ml/g and 1.44 ml/g, and a pore size distribution having a micro- to meso-pore ratio of between 10.3 and 5.3.

### Example 2

### Processing of Coconut Shell Activated Carbon in Preparation for Chemical Washing

Activated carbon produced as described in Example 1 was subjected to a number of processing steps to prepare the activated carbon for chemical washing.

First, activated carbon was de-stoned to remove any sand/stone still present. Standard de-stoning equipment common to the rice industry was used. Specifically, feed carbon particles, having a size distribution of 90% between 5.0 mm and 3.2 mm and/or 8.0 mm and 5.0 mm, are de-stoned to separate the high density fraction in the feed material. The resulting high density fraction had a bulk density of about 0.5 g/cm³ and a particle density greater than about 1.0 g/cm³.

The activated carbon was then blended in a rotary blender for 15-45 minutes at 5-7 rpm to reach homogeneity.

After blending, the activated carbon was then subjected to primary crushing, density separation, secondary crushing, screening, and magnetic separation.

Primary crushing was conducted with a roller mill crusher and resulted in irregularly shaped particles, with a size distribution of 90% or greater within ASTM mesh sizes 12 and 40.

After primary crushing, bulk density separation was conducted to assure that the activated carbon had a bulk density of between about 0.1 g/cm³ and 0.5 g/cm³.

Secondary crushing was then performed with a roller mill crusher to more finely crush the refined product and ensure proper sizing and shape of the carbon particles. Secondary crushing resulted in particles with a size distribution of 90% or greater within ASTM mesh sizes 30 and 100.

After secondary crushing, the activated carbon was screened with a gyratory screener to get a particle size distribution of 95% within ASTM mesh sizes 30 and 100.

As a final preparatory step, the screened material was subjected to magnetic separation with rollers having peak magnetic intensity of 10,000 Gauss. This treatment reduced the presence of magnetic particles from 0.3% or more to about 0.001% or less.

### Example 3

### Reduction of Impurities by Chemical Washing

The activated carbon material from Example 2 was then subjected to a chemical washing protocol to reduce impurities.

The activated carbon material was first washed with aqueous hydrochloric acid with a concentration of between about 0.1 N and 0.2 N by soaking for between about 5 minutes and 2 hours. The volume of hydrochloric acid used was between about 6 to 12 times the volume of the activated carbon.

The hydrochloric acid was then drained, and replaced with aqueous nitric acid with a concentration of between about 0.05 N and 0.1 N. The activated carbon was soaked in about 5 times its volume of nitric acid for 3 to 6 hours.

The nitric acid was then drained, and the acid soaked carbon was washed with about 3 to 6 times its volume with de-ionized water.

After the water wash, the activated carbon was then washed with aqueous ammonium hydroxide with a concentration of about 0.02 N to 0.2 N. The activated carbon was soaked in about 2 to 4 times its volume of the ammonium hydroxide solution for at least about 1 hour.

The ammonium hydroxide solution was drained off, and the activated carbon again washed with another 3 to 5 times its volume with de-ionized water,

After the second water wash, the activated carbon was again soaked in about 1 to 3 times its volume of aqueous hydrochloric acid, again with a concentration of between about 0.1 N and 0.2 N, for at least about 1 hour.

The second hydrochloric acid soak solution was drained off, and the activated carbon soaked in about 3 to 6 times its volume of de-ionized water for about 50 minutes.

After the water soak, the water was drained off and about 1 to 3 times its volume of about 2 N aqueous ammonium hydroxide was passed through the activated carbon.

The activated carbon was then again soaked in about 5 times its volume of de-ionized water.

Again the de-ionized water was drained off and the activated carbon was soaked in about 1 volume of 5% aqueous sodium hydroxide solution for at least 2 hours.

The sodium hydroxide solution was then drained off, and the activated carbon again rinsed with about 3 to 7 volumes of de-ionized water, for between 1 and 10 hours.

After this water rinse, the activated carbon was again soaked in aqueous hydrochloric acid, this time at a concentration between about 0.2 N and 0.4 N for at least 4.5 hours.

The hydrochloric acid solution was then drained off, and the activated carbon rinsed again with 0.2 N to 0.4 N nitric acid for at least 1.5 hours.

After the nitric acid rinse, the activated carbon was again soaked in about 2 to 4 volumes of 0.3 to 0.5 N aqueous ammonium hydroxide for 0.5 to 4 hours.

Finally, the activated carbon was soaked in about 5 to 10 volumes of de-ionized water for at least 5 hours and drained.

The chemically washed activated carbon was then dried in an indirectly heated rotary dryer at a temperature of between 150° C. and 300° C. at a rate of between 200 and 500 kg/hr. After drying the activated carbon product was physically stable, black granules having moisture content of less than 2%.

### Example 4

### Ash Content and Analysis of Activated Carbon after Chemical Washing

Activated carbon subjected to the chemical washing of Example 3 was then analyzed for calcined ash content according to ASTM D2866-94 (2004). The composition of the remaining calcined ash was also determined by atomic adsorption spectroscopy or conventional ICP techniques. Results of these analyses are shown in Table 2.

TABLE 2
Ash content of chemically washed coconut shell activated carbon

| Constituent | (units) | Value |
|---|---|---|
| Ash Content | % | <0.05 |
| Ash Content | ppm | <500 |
| Water Soluble Matter | % | <0.01 |
| Acid Soluble Matter | % | <0.025 |
| Fe | ppm | <10 |
| Na | ppm | <25 |
| K | ppm | <50 |
| Ca | ppm | <25 |
| Mg | ppm | <25 |
| Cl⁻ | ppm | <50 |
| S | ppm | <150 |
| Ni | ppm | <1.5 |
| Cr | ppm | <1.5 |
| Cu | ppm | <2.5 |
| Mn | ppm | <2.5 |

### Example 5

### Processing of Low Ash Activated Carbon for Modification of Surface Functional Groups

Dried activated carbon prepared as described in Example 4 was further subjected to magnetic separation to ensure a magnetic particle presence of less that or equal to about 0.001%.

The resulting activated carbon was then heated in a nitrogen gas environment to temperatures about 800° C. to 1100° C. for 2 to 4 hours for controlled reduction of surface oxygen and other surface functional groups. The resulting activated carbon had total surface oxygen content of less than about 1.2%, total nitrogen content of less than or equal to about 0.2%, and total hydrogen content of less than or equal to 0.9%. Carboxylic, hydroxyl, and lactone functional groups were present at less at a total of than 0.3 miliequivalent/g.

### Example 6

### Processing of Surface-Modified Low Ash Activated Carbon for Use in Polarizing Electrodes

Activated carbon prepared according to Example 5 was then milled to achieve a preferred particle size distribution for use as a polarizing electrode material. The particle size distribution of the activated carbon product selected for electrode testing was as follows: D₁₀=1.5-3 microns; D₅₀=5.0-7.0 microns; D₉₀=11.0-15.0 microns; and D₁₀₀=30 microns.

### Example 7

### Electrode Performance

Polarizing electrodes comprising activated carbon prepared as described in Example 6 were constructed and tested for performance. Four electrodes were constructed with a thickness of 250±20 mm at a loading rate of 12±2 mg/cm². These electrodes had densities of 0.57 g/cm³ to 0.59 g/cm³, with carbon densities at the electrode between 0.48 g/cm³ and 0.50 g/cm³.

Electrode performance was measured in a fuel cell with 1M Et₄NBF₄ in acetonitrile (at <20 ppm H₂O) as the electrolyte solution. The capacitance and ESR of the four electrodes are shown in Table 3.

TABLE 3
Performance of low ash activated carbon electrodes

| Property (units) | Electrode 1 | Electrode 2 | Electrode 3 | Electrode 4 |
|---|---|---|---|---|
| Carbon Density | 0.48 | 0.48 | 0.49 | 0.50 |
| (at electrode) | | | | |
| (g/cm³) | | | | |
| Electrode | 0.57 | 0.57 | 0.58 | 0.59 |
| Density | | | | |
| (g/cm³) | | | | |
| Capacitance | 124 | 124 | 127 | 129 |
| (25° C., 2.5 V) | | | | |
| (F/g) | | | | |
| Capacitance | 62.2 | 67.5 | 64.3 | 61.0 |
| (25° C., 2.5 V) | | | | |
| (F/cm³) | | | | |
| ESR | 0.56 | 0.65 | 0.75 | 0.60 |
| (Ohm) | | | | |

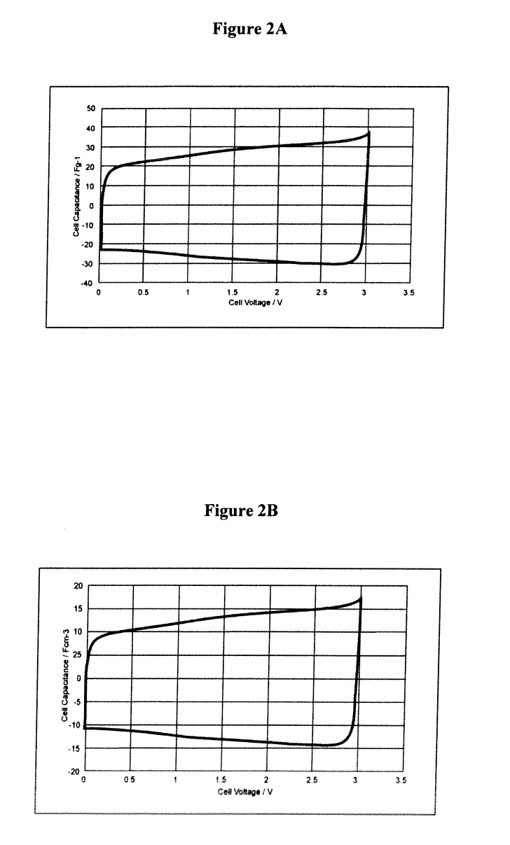

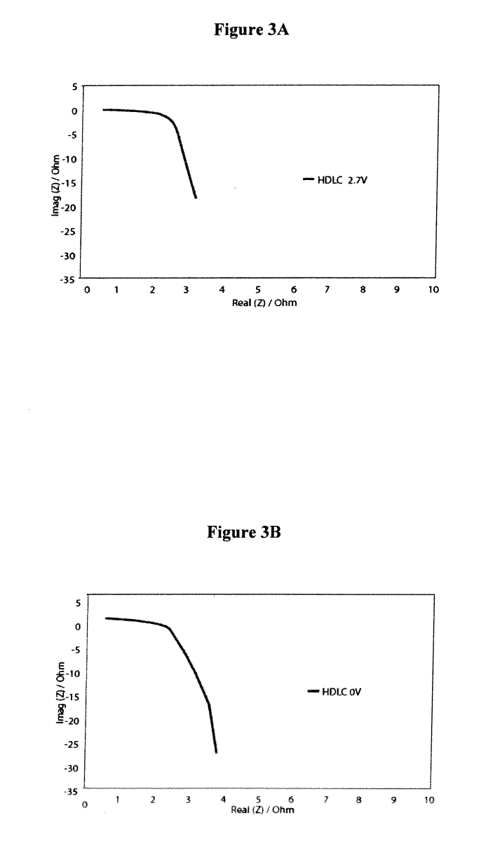

Exemplary cyclic voltammograms generated from these electrodes are shown in FIGS. 2A and 2B. Two exemplary electrochemical impedance spectra are shown in FIGS. 3A and 3B.

The contents of the articles, patents, and patent applications, and all other documents and electronically available information mentioned or cited herein, are hereby incorporated by reference in their entirety to the same extent as if each individual publication was specifically and individually indicated to be incorporated by reference. Applicants reserve the right to physically incorporate into this application any and all materials and information from any such articles, patents, patent applications, or other physical and electronic documents.

The methods illustratively described herein may suitably be practiced in the absence of any element or elements, limitation or limitations, not specifically disclosed herein. Thus, for example, the terms “comprising”, “including,” containing”, etc. shall be read expansively and without limitation. Additionally, the terms and expressions employed herein have been used as terms of description and not of limitation, and there is no intention in the use of such terms and expressions of excluding any equivalents of the features shown and described or portions thereof. It is recognized that various modifications are possible within the scope of the invention claimed. Thus, it should be understood that although the present invention has been specifically disclosed by preferred embodiments and optional features, modification and variation of the invention embodied therein herein disclosed may be resorted to by those skilled in the art, and that such modifications and variations are considered to be within the scope of this invention.

The invention has been described broadly and generically herein. Each of the narrower species and subgeneric groupings falling within the generic disclosure also form part of the methods. This includes the generic description of the methods with a proviso or negative limitation removing any subject matter from the genus, regardless of whether or not the excised material is specifically recited herein.

Other embodiments are within the following claims. In addition, where features or aspects of the methods are described in terms of Markush groups, those skilled in the art will recognize that the invention is also thereby described in terms of any individual member or subgroup of members of the Markush group.

That which is claimed is:

1. An activated carbon from a natural carbonaceous source material, said activated carbon comprising less than 500 ppm calcined ash.

2. The activated carbon of claim 1, wherein said activated carbon comprises less than about 400 ppm calcined ash.

3. The activated carbon of claim 1, wherein said activated carbon comprises less than about 350 ppm calcined ash.

4. The activated carbon of claim 1, wherein said activated carbon comprises less than about 35 ppm chloride.

5. The activated carbon of claim 1, wherein said activated carbon comprises particles with the size distribution D₁₀=about 2.0-3.5 microns; D₅₀=about 7.0-9.0 microns; D₉₀=about 15.0-18.0 microns; and D₁₀₀=about 45.0 microns.

6. The activated carbon of claim 1, wherein said activated carbon comprises particles with the size distribution D₁₀=about 1.5-3.0 microns; D₅₀=about 5.0-7.0 microns; D₉₀=about 11.0-15.0 microns; and D₁₀₀=about 30.0 microns.

7. The activated carbon of claim 1, wherein said activated carbon comprises particles with the size distribution D₁₀=about 1.0-2.0 microns; D₅₀=about 3.0-7.0 microns; D₉₀=about 9.0-11.0 microns; and D₁₀₀=about 25.0 microns.

8. The activated carbon of claim 1, wherein said activated carbon comprises particles with the size distribution D₁₀=about 0.2-0.5 microns; D₅₀=about 2.0-3.0 microns; D₉₀=about 3.0-4.0 microns; and D₁₀₀=about 7.0-10.0 microns.

9. The activated carbon of claim 1, wherein said activated carbon comprises less than about 1.2% surface oxygen.

10. The activated carbon of claim 1, wherein said activated carbon comprises less than about 0.2% nitrogen.

11. The activated carbon of claim 1, wherein said activated carbon comprises less than about 0.9% hydrogen.

12. The activated carbon of claim 1, wherein said activated carbon comprises less than about 0.3 miliequivalents per gram total —COOH, hydroxyl, and lactone functional groups.

13. The activated carbon of claim 1, wherein said activated carbon has a density within the range of about 0.35 to 0.40 g/cc.

14. The activated carbon of claim 1, wherein said activated carbon has a BET surface area of about 1700 to 3200 m²/g.

15. The activated carbon of claim 14, wherein said activated carbon has a BET surface area of about 1700 to 2500 m²/g.

16. The activated carbon of claim 1, wherein said activated carbon has an iodine adsorption of about 1700 to 2000 mg/g.

17. The activated carbon of claim 1, wherein said activated carbon has a benzene adsorption in the range of about 60.5% to 100%.

18. The activated carbon of claim 1, wherein said activated carbon has a pore volume of about 0.8 to 2.0 cc/g.

19. The activated carbon of claim 1, wherein said activated carbon has an average pore diameter of about 18 to 21 Angstroms.

20. The activated carbon of claim 1, wherein said activated carbon is activated via steam activation.

21. The activated carbon of claim 1, wherein said natural carbonaceous source material comprises a char derived from coconut shell source material.

22. The activated carbon of claim 21, wherein said char is derived from coconut shell source material via carbonization in an inert atmosphere.

23. The activated carbon of claim 21, wherein said char is derived from coconut shell source material via carbonization in an oxygen containing atmosphere.

24. The activated carbon of claim 1, wherein said activated carbon is washed with at least one acidic solution to reduce calcined ash.

25. The activated carbon of claim 1, wherein said activated carbon is washed with at least one basic solution to reduce calcined ash.

26. The activated carbon of claim 1, wherein said activated carbon is washed with a plurality of basic solutions to reduce calcined ash, wherein said plurality of basic solutions are increasingly basic.

27. The activated carbon of claim 1, wherein said activated carbon is washed with at least one acid and at least one base to reduce calcined ash.

28. The activated carbon of claim 1, wherein said activated carbon is washed with at least one acid followed by at least one base to reduce calcined ash.
